(19) United States
(12) Patent Application Publication
(10) Pub. No.: US 2007/0255946 A1
(43) Pub. Date: Nov. 1, 2007

(54) Information processing apparatus and authentication method

(75) Inventor: Tomoyuki Kokubun, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/785,500

(22) Filed: Apr. 18, 2007

(30) Foreign Application Priority Data
Apr. 28, 2006 (JP) 2006-127038

(51) Int. Cl. H04L 9/00

(52) U.S. Cl. 713/159

(57) ABSTRACT

According to one embodiment, an information processing apparatus is provided with the following a body, an input section configured to input authentication information to the body, authentication means for executing first authentication processing by comparing authentication information input from the input section with first registration information stored in the body, means for receiving a result of second authentication processing executed by comparing the authentication information input from the input section with second registration information, a storage device configured to store authentication log information, means for additionally writing authentication failure information in the authentication log information if the first authentication processing fails, and means for adding the authentication failure information to the authentication log information if the receiving means is informed that the second authentication processing fails.

### CROSS-REFERENCE TO RELATED APPLICATIONS

This application is based upon and claims the benefit of priority from Japanese Patent Application No. 2006-127038, filed Apr. 28, 2006, the entire contents of which are incorporated herein by reference.

### BACKGROUND

1. Field

One embodiment of the invention relates to an information processing apparatus requiring authentication processing, and to an authentication method.

2. Description of the Related Art

An information processing apparatus such as a computer authenticates the user by prompting the user to enter a password on start-up and comparing the entered password with pre-stored information for authentication processing.

A system in which a password is entered from a keyboard copes with a malicious third party who tries every possible combination of numbers, by limiting the number of times a password can be entered. In other words, if the number of times authentication failure occurs exceeds a predetermined number, the information processing apparatus is disabled (See Jpn. Pat. Appln. KOKAI Publication No. 2002-288137).

Currently, authentication is required not only when the user logs in to the computer but also when the user accesses a server on a network. Conventionally, these authentication processes have been managed individually.

Even if one of the passwords entered within a limited number of times happens to agree with the real password, the authentication process is regarded as having ended successfully. This does not guarantee high levels of security.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an information processing apparatus according to one embodiment of the present invention;

FIG. 2 is an exemplary block diagram illustrating the system configuration of the information processing apparatus shown in FIG. 1;

FIG. 3 is an exemplary flowchart illustrating how the information processing apparatus shown in FIG. 1 executes the authentication process after the power supply is turned on;

FIG. 4 illustrates the processing which the information processing apparatus shown in FIG. 1 executes when it is connected to a shared folder of a network requiring authentication;

FIG. 5 illustrates the process which the information processing apparatus shown in FIG. 1 executes after it is logged on to the operating system normally; and

FIG. 6 shows an example of a warning window which an LCD displays when the number of times the authentication fails exceeds a predetermined number of times.

### DETAILED DESCRIPTION

Various embodiments according to the invention will be described hereinafter with reference to the accompanying drawings. In general, according to one embodiment of the invention, an information processing apparatus comprises a body, an input section configured to input authentication information to the body, an authentication processing section configured to execute first authentication processing by comparing authentication information input from the input section with first registration information stored in the body, an authentication result receiving section configured to receive a result of second authentication processing executed by comparing the authentication information input from the input section with second registration information, a storage device configured to store authentication log information, a first authentication processing failure information-writing section configured to additionally write authentication failure information in the authentication log information if the first authentication processing fails, and a second authentication processing failure information-writing section configured to write the authentication failure information in the authentication log information if the authentication result receiving section is informed that the second authentication processing fails.

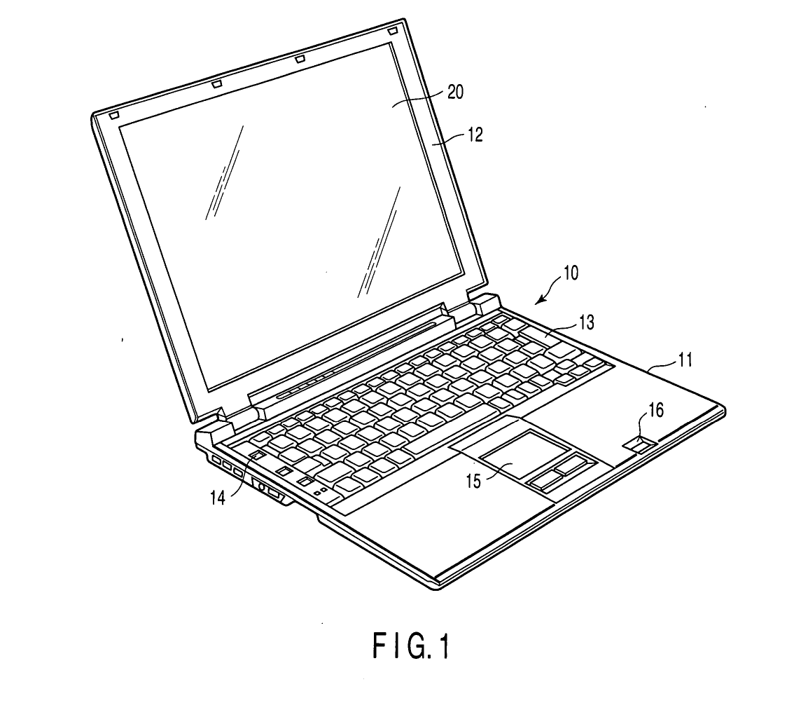

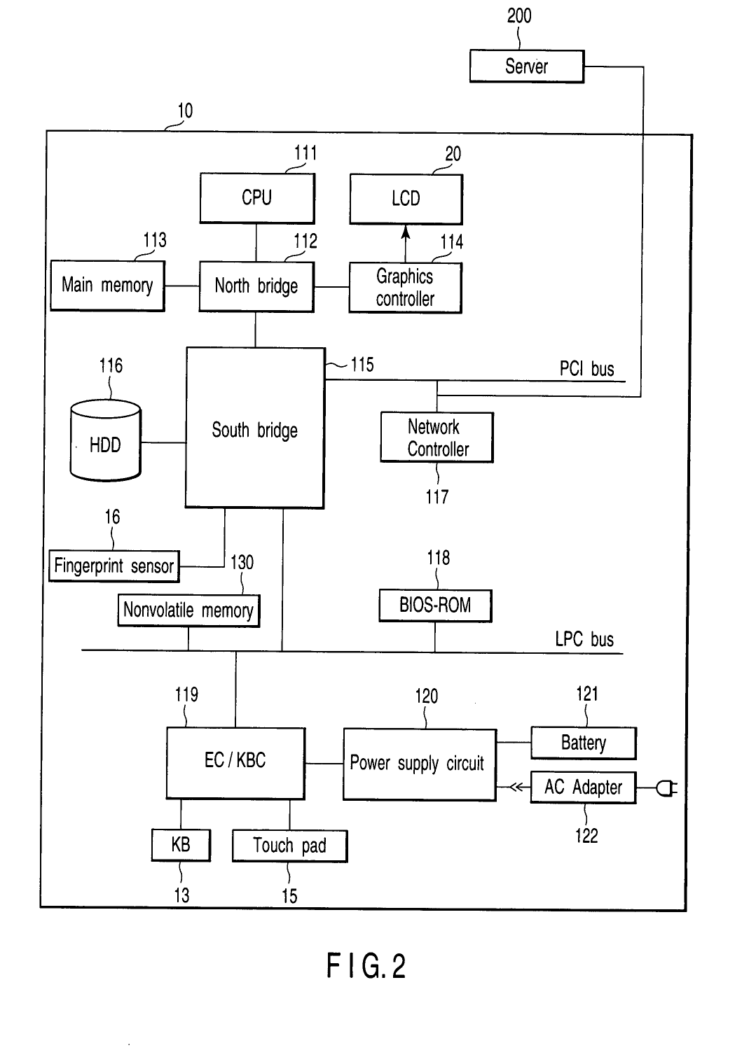

An information processing apparatus according to the first embodiment of the present invention will be described, referring to FIGS. 1 and 2. In the embodiment, the information processing apparatus is realized as a notebook personal computer 10, which is portable and can be driven by a battery.

FIG. 1 is a perspective view showing the front portion of the computer 10. In FIG. 1 the computer 10 is in the open state.

The computer 10 comprises a computer main body 11 and a display unit 12. The display unit 12 incorporates a display device made of a liquid crystal display (LCD) 20. The display screen of the LCD 20 is located substantially in the center of the display unit 12.

The display unit 12 is supported by the computer main body 11 and is rotatable relative to the computer main body 11. The display unit 12 is rotatable between an open position where the upper surface of the computer main body 11 is exposed and a closed position where the upper surface of the computer main body 11 is covered. The computer main body 11 comprises a thin, box-shaped casing, and a keyboard 12, a power button 14 (by which the computer 10 is turned on or off), and a touch pad 15 are arranged on the upper surface of the computer main body 11. A fingerprint sensor 16, which reads a fingerprint of the user as biological information, is also arranged on the upper surface of the computer main body 11.

FIG. 2 shows an example of a system configuration of the computer 10.

The computer 10 is provided with: a CPU 111, a north bridge 112, a main memory 113, a graphic controller 114, a south bridge 115, a hard disk drive (HDD) 116, a network controller 117, a flash BIOS-ROM 118, embedded controller/keyboard controller IC(EC/KBC) 119, a power supply circuit 120, etc.

The CPU 111 is a processor that controls the operation of each component of the computer 10. The CPU 111 executes an operating system and various types of application programs and utility programs, which are loaded in the main memory 113 from the HDD 113. The CPU 111 also executes a system BIOS (Basic Input Output System) stored in the BIOS-ROM 118. The system BIOS is a program for hardware control.

The north bridge 112 is a bridge device connecting the local bus of the CPU 111 and the south bridge 115. The north bridge 112 has a function of performing communications with the graphic controller 114 by means of an AGP (Accelerated Graphics Port) bus. The north bridge 112 incorporates a memory controller for controlling the main memory 113.

The graphic controller 114 is a display controller for controlling the LCD 20, which is used as the display monitor of the computer 10. The south bridge 115 is connected to both a PCI (Peripheral Component Interconnect) bus and an LPC (Low Pin Count) bus.

The embedded controller/keyboard controller (EC/KBC)IC (hereinafter referred to as EC/KBC) 119 is a one-chip microcomputer in which an embedded controller (used for power supply management) and a keyboard controller (used for controlling a keyboard (KB) 13 and a touch pad 15) are integrated. The embedded controller/keyboard controller IC119 cooperates with the power supply circuit 120 and turns on/off the computer in accordance with a user's operation of the power button 14. The power supply circuit 120 generates system power to be applied to each component of the computer 10 by using external power which is provided through an AC adapter 122.

The computer 10 can communicate with a server 200 by way of the network controller 117.

The computer 10 can skip the authentication process which is executed by the system BIOS and/or the authentication process which is executed at the time of logon to the operating system. Instead of executing these, the computer 10 executes a BIOS biometric process. The system BIOS compares a user's fingerprint the user enters by use of the fingerprint sensor 16 with a fingerprint registered in the computer beforehand and the user is authenticated based on the result of comparison.

When the computer is turned on, when the OS logon is performed, and when a website requiring authentication is accessed, the system BIOS and utility executed by the CPU 11 acquire input information. The acquired log information is stored, for example, in a nonvolatile memory 130 provided in the BIOS-ROM. To prevent the log information from being tampered, it is desired that the nonvolatile memory 130 be protected by the system. Alternatively, the log information is encrypted and is then stored in the HDD 116. The information may be stored in a storage device for which protection measures are taken.

Examples of log information are shown in Table 1 set forth below.

TABLE 1

| | | Fail/ | Input |
|---|---|---|---|
| Time Stamp | Method | Success | Contents |
| 2005-12-1 | Fingerprint | Fail | (Scanned |
| 23:12:30.00 | | | fingerprint |
| | | | data) |
| 2005-12-1 | KB Input | Fail | XXXX |
| 23:12:31.00 | | | (Data Entered |
| | | | from KB) |
| . . . | . . . | . . . | . . . |
| 2005-12-2 | Fingerprint | Success | |
| 08:55:00.30 | | | |
| . . . | . . . | | . . . |

As shown in Table 1, the log information includes the dates of authentication (time stamps), the methods for authentication, authentication results (success/fail), and authentication result information such as input contents entered when the authentication result is “Fail”.

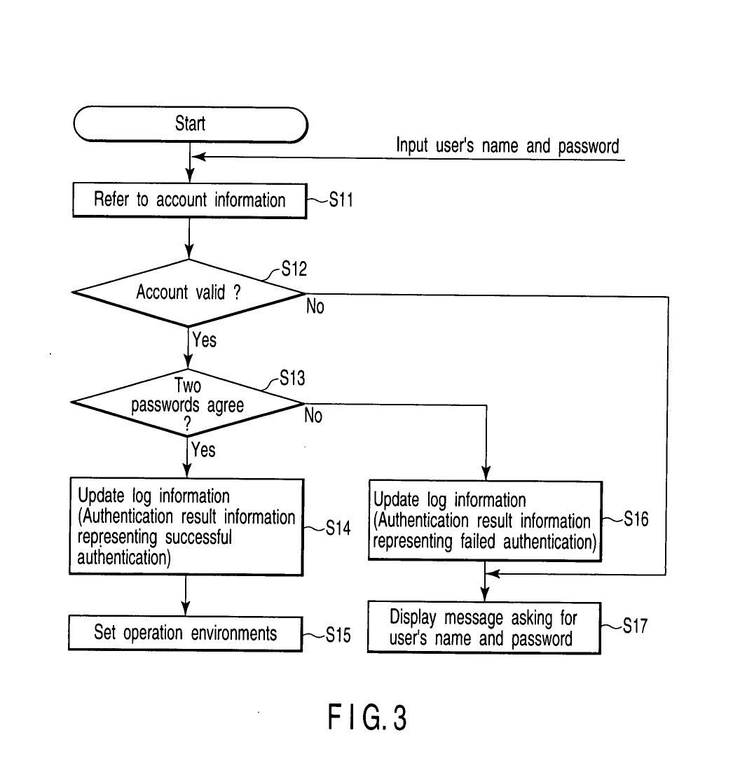

A description will now be given with reference to FIG. 3 as to how the authentication processing the computer 10 is performed. The authentication processing is logon authentication processing for determining whether the user is entitled to log on (or log in) the operating system. The logon authentication processing is executed by the operating system.

When the user enters a user's name and a password from the keyboard 13 serving as an input section, the operating system refers to the account information stored in the HDD 116 (Step S11). The account information includes a user's name, a password, information representing whether the account of the user's name is valid or not, etc. If the account of the user's name is not valid, the user cannot log on the operating system by entering that user's name.

The operating system determines whether the account of the user's name, which the user enters, is valid or not (Step S12). If the account is not valid (“No” in Step S12), the operating system executes ordinary processing that should be performed when the authentication fails. For example, the operating system controls the LCD 20 to display a message asking the user to input a user's name and a password (Step S17).

When the account is valid (“Yes” in Step S12), determination is made to see whether the entered password agrees with a password of the account information (Step S13).

When the two passwords agree with each other (“Yes” in Step S13), the utility adds the following information to the log information: (i) the time of authentication processing and (ii) the authentication result information representing that the authentication processing has been successfully performed (Step S14). Then, the ordinary processing that should be performed when the authentication has been successfully performed is executed. For example, the operating system starts setting the operation environments corresponding to the logged-on user. Where the two passwords agree with each other, the authentication information need not be added to the log information.

If the two passwords do not agree in the determination processing in Step S13 (“No” in Step S13), then the utility additionally writes the following information to the log information: the time of authentication processing, authentication method, and the authentication result information representing that the authentication processing has resulted in failure (Step S16).

Then, the operating system executes the ordinary processing that should be performed when the authentication has resulted in failure (Step S17).

In the above description, reference was made to the case where the user logs on the operating system. Log information may be prepared likewise in the BIOS authentication processing which the system BIOS executes when the power switch is turned on. In the case of the BIOS authentication processing, the system BIOS performs the authentication processing and prepares log information.

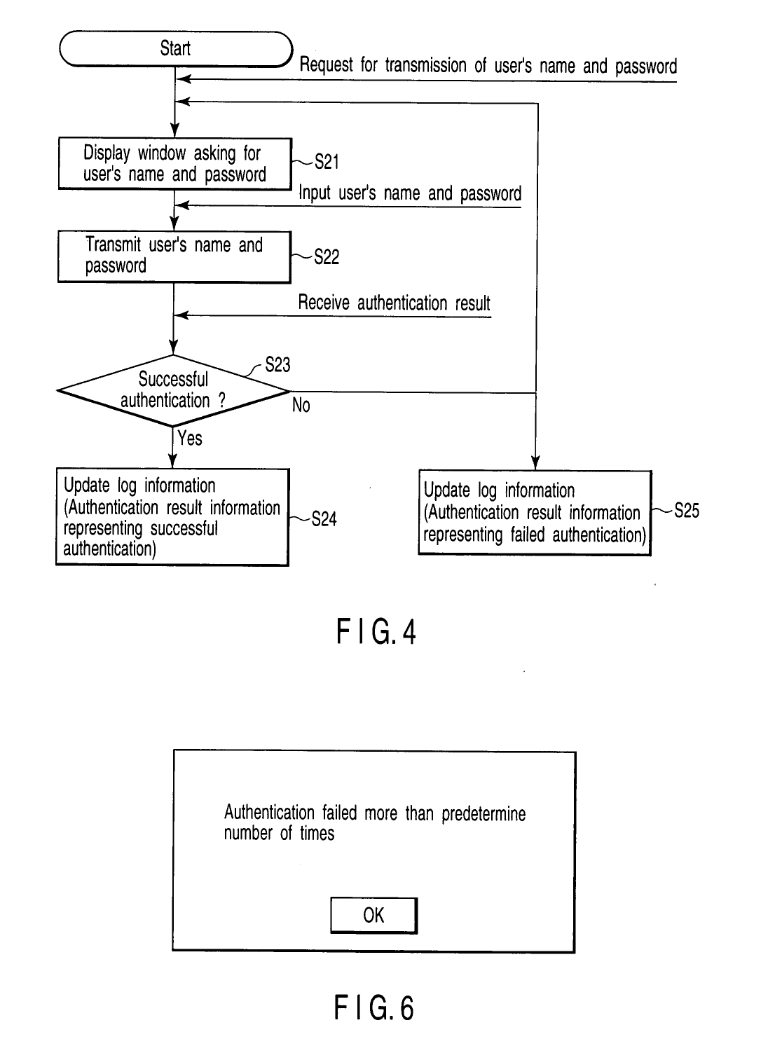

A description will now be given with reference to FIG. 4 as to how to access a shared folder of a network requiring authentication.

When the user tries to access a shared folder requiring authentication, the server 200 issues a request asking that the computer 10 transmit a user's name and a password. Upon receipt of this request, the computer 10 controls the LCD 20 to show a window prompting the user to enter a user's name and a password (Step S21).

The user enters the user's name and password in the window, and the operating system transmits them to the server 200 (Step S22). The server 200 compares the user's name and password it receives with the authentication information stored in the server 200. The server 200 executes authentication processing based on this comparison and transmits the results of authentication to the computer 10.

After the computer 10 receives the results of authentication, the operating system and the utility determine whether the authentication has been successfully performed (Step S23).

When it is determined that the authentication has been successfully performed (“Yes” in Step S23), the utility additionally writes the successful authentication to the log information (Step S24). In addition, the operating system controls the LCD 20 to show the folders and files within the shared folder which are transmitted from the server 200.

When it is determined that the authentication has resulted in failure (“No” in Step S23), the utility writes the authentication failure in the log information (Step S25). In addition, the operating system controls the LCD 20 to show a window prompting the user to enter a user's name and a password again.

The two kinds of authentication processing have been described. The system BIOS or utility additionally writes the results of all kinds of authentication processing in the log information, as long as an application which the CPU executes can detect the results of authentication. The kinds of authentication processing include (i) the authentication processing which the operating system and the system BIOS perform, and (ii) authentication processing performed based on the communication between the operating system and the server 200.

The utility additionally writes authentication results and authentication information in the log information when a web site requiring authentication processing is accessed.

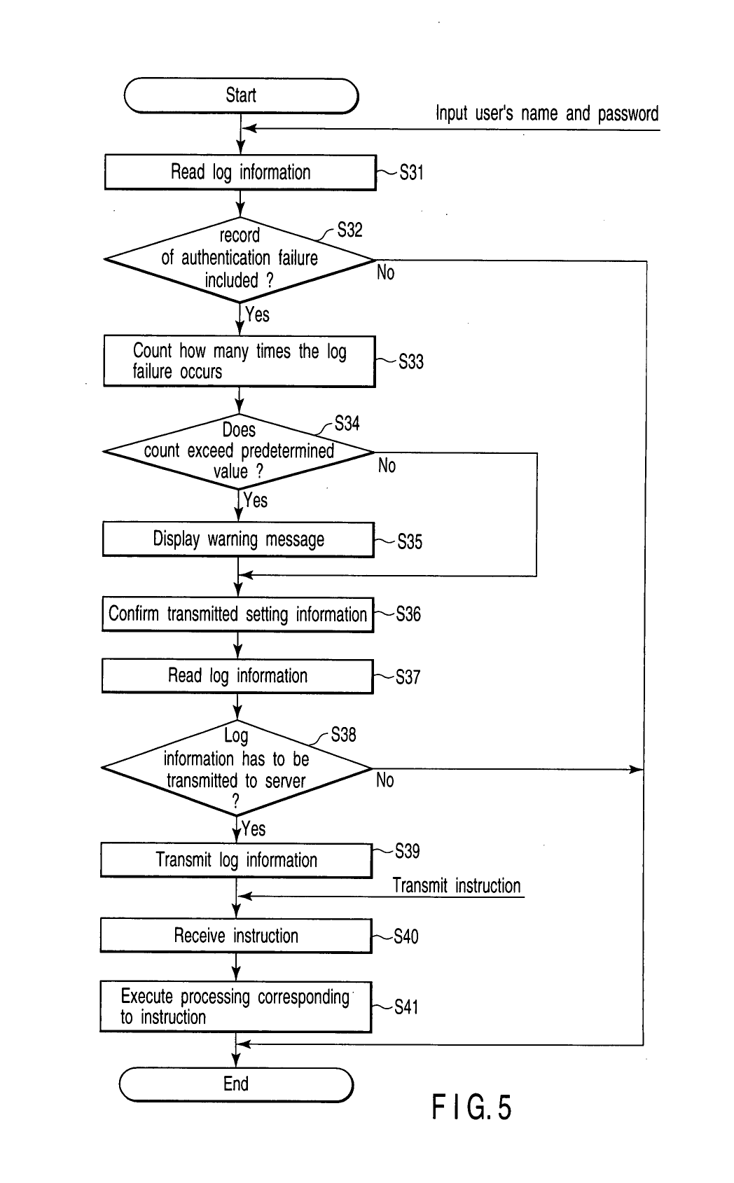

A description will now be given with reference to FIG. 5 of the processing which the utility executes, referring to the log information. This processing is executed immediately after the user logs on the operating system normally or at regular times during the logon.

The utility reads the log information (Step S31). The utility determines whether the log information includes a record of authentication failure (Step S32). Where the determination shows that the log information does not include a record of authentication failure (“No” in Step S32), the utility terminates the processing. Where the determination shows that the log information includes a record of authentication failure (“Yes” in Step S32), the utility refers to the log information and counts how many times the log failure occurs (Step S33). Then, the utility determines whether the count exceeds a predetermined value (Step S34).

Where the count exceeds the predetermined value, then the utility controls the LCD 20 to display a warning message (FIG. 6), which indicates that the user has failed in the authentication processing more than the predetermine number of times (Step S35). The utility may control the LCD 20 to display the log information together with the warning message.

After the processing in Step S35, or if it is determined in step S34 that the count does not exceed the predetermined value (“No” in Step S34), the utility reads setting information (Step S36), and then reads log information (Step S37).

The setting information read in Step S36 and the log information read in Step S37 are compared with each other. Based on this comparison, it is determined whether the log information has to be transmitted to the server 200 administered by the administrator (Step S38). The times when the log information is transmitted can be determined in several ways. That is, the log information may be transmitted whenever authentication failure occurs; it may be transmitted when authentication failure occurs more than a predetermined number of times; or it may be transmitted regularly.

When it is determined that the log information need not be transmitted (“No” in Step S38), the utility ends the processing. When it is determined that the log information has to be transmitted (“Yes” in Step S38), the utility attaches the log information to email and sends this email to the server 200.

Upon receipt of the log information, the server 200 analyzes it and transmits an instruction based on the analysis to the computer 10. The server may automatically administer the analysis and the transmission of the instruction. Alternatively, the administrator who administers the server 200 may perform these operations.

Upon receipt of the instruction (Step S40), the computer 10 executes processing corresponding to the instruction (Step S41).

A description will be given of examples of the instruction and processing.

When the administrator analyzes the user data and judges that the current user is not the authenticated user, the server 200 transmits an instruction to the computer 10 to make the account of the logged-in user invalid. Then, the server 200 is so set as to execute shutdown processing after a predetermined time and transmits data to the computer. The data is for causing the LCD 20 to show that the shutdown processing is to be executed after the predetermined time and that the account is to be made invalid. The operating system of the computer makes the account invalid, and the utility displays a message to the effect that the shutdown processing is to be executed after the predetermined time. When the predetermined time has elapsed, the operating system executes the shutdown processing. The operating system may make the account invalid without executing shutdown processing. In this case, the LCD 20 displays a message that the account has been made invalid when the LCD 20 is actuated next.

Where the analysis of the log information indicates that the authentication is based on a typed input, and that the currently logged-in user is the authenticated user, the server 200 causes the LCD 20 to display a message asking the user to change the password in accordance with the type of failure. If the failure is attributable to a so-called “lexical attack”, the LCD 20 displays a message indicating that a general word should be avoided. If the password can be imagined on the basis of the personal information on the authenticated user, then the LCD 20 displays a message that such an easily imaginable password should be changed to another.

Where the administrator determines based on the analysis that the authentication failure is a failure in fingerprint authentication, the server 200 asks the user to change the finger for authentication to another. If the cracker has a high-level skill and can prepare a gummy finger by utilizing an object touched by the authenticated user, the use of a different finger for authentication is meaningless. Unless the cracker has a high-level skill, the log information inevitably includes data on the fingerprint or finger of the cracker, and the administrator can identify the cracker. Even in the case of an attack using a gummy finger, it is hard to make a gummy finger that is so precise as to enable authentication by one-time trial, and the administrator can identify the finger whose information is stolen from the log information. If the attack is tried by use of a gummy finger that is presumably an index finger, the administrator can delete the registration of the index finger from the LCD 20 and control the LCD to display a message asking for the registration of another finger.

Where the administration failure is attributable to a solid-state device (a token) such as a USB key, its ID is stored in the log information. If the administrator judges that the ID should be made invalid, the administrator performs settings that makes the ID invalid next time or after a predetermined time, and controls the LCD 20 to show a message to this effect.

In the conventional art, the number of times authentication fails is counted for each type of authentication (in the case of the OS logon, the number of times the authentication fails is counted immediately before the OS logon), and suitable measures are taken if the counted number exceeds a predetermined number of times. In contrast, according to the embodiment, all types of authentication are managed in an integrated fashion. Therefore, if the total number of times authentication fails exceeds a predetermine number of times, all types of authentication can be temporarily prohibited (a special password can be used to resume the authentication process). The security of authentication process can be improved, accordingly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body;
an input section configured to input authentication information to the body;
an authentication processing section configured to execute first authentication processing by comparing authentication information input from the input section with first registration information stored in the body;
an authentication result receiving section configured to receive a result of second authentication processing executed by comparing the authentication information input from the input section with second registration information;
a storage device configured to store authentication log information;
a first authentication processing failure information-writing section configured to additionally write authentication failure information in the authentication log information if the first authentication processing fails; and
a second authentication processing failure information-writing section configured to write the authentication failure information in the authentication log information if the authentication result receiving section is informed that the second authentication processing fails.

2. The information processing apparatus according to claim 1, wherein the authentication failure information includes information on at least one of: a time of authentication, an authentication method, and authentication data input from the input section.

3. The information processing apparatus according to claim 1, further comprising:
a count section configured to count the number of times of failure registered in the authentication information;
a determination section configured to determine whether the number of times of failure is greater than a predetermined number of times; and
an output section configured to output a message when the number of times of failure is greater than the predetermined number of times.

4. The information processing apparatus according to claim 1, further comprising:
a first determination section configured to determine whether or not the authentication failure information is included in the authentication log information;
a second determination section configured to determine whether the authentication log information should be transmitted to a server if the authentication failure information is included in the authentication log information; and
a transmitting section configured to transmit the authentication log information to the server when the second determination section determines that the authentication log information should be transmitted to the server.

5. The information processing apparatus according to claim 4, further comprising:
a processing execution section configured to execute processing corresponding to an instruction sent from the server after the authentication log information is transmitted to the server.

6. The information processing apparatus according to claim 1, wherein the authentication log information is encrypted.

7. The information processing apparatus according to claim 1, wherein the storage device is protected by a system.

8. An authentication processing method for use in an information processing apparatus comprising (i) a first a authentication processing section configured to execute first authentication processing by comparing input authentication information with registered first registration information and (ii) a second authentication result receiving section configured to receive a result of second authentication processing executed by comparing input second authentication information with second registration information, the method comprising:
executing one of the first authentication processing and the second authentication processing; and
additionally writing authentication failure information in authentication log information if one of the first authentication processing and the second authentication processing fails.

9. The authentication method according to claim 8, wherein the authentication information includes information on at least one of: a time of authentication, an authentication method, and authentication data input by a user.

10. The authentication method according to claim 8, further comprising:
counting the number of times of failure registered in the authentication information;
determining whether the number of times of failure is greater than a predetermined number of times; and
outputting a message when the number of times of failure is greater than the predetermined number of times.

11. The authentication method according to claim 8, further comprising:
determining whether or not the authentication failure information is included in the authentication log information;
determining whether the authentication log information should be transmitted to a server if the authentication failure information is included in the authentication log information; and
transmitting the authentication log information to the server when it is determined that the authentication log information should be transmitted to the server.

12. The authentication method according to claim 11, further comprising:
executing processing corresponding to an instruction sent from the server after the authentication log information is transmitted to the server.
